(19) United States
(12) Patent Application Publication
(10) Pub. No.: US 2007/0214656 A1
(43) Pub. Date: Sep. 20, 2007

(54) Arm brace knife and method

(76) Inventor: Marvin L. Gray, Tacoma, WA (US)

Correspondence Address: DEAN A. CRAINE, SUITE 140, 400 - 112 TH AVENUE NE, BELLEVUE, WA, 98004, US

(21) Appl. No.: 11/724,946

(22) Filed: Mar. 16, 2007

Related U.S. Application Data
(60) Provisional application No. 60/783,112, filed on Mar. 16, 2006.

(51) Int. Cl. B26B 29/00; B26B 27/00

(52) U.S. Cl. 30/295; 30/298

(57) ABSTRACT

A knife used for cutting thick material, such as insulation that includes an elongated handle with an elongated blade longitudinally aligned and attached to the handle's distal end. Formed over the top edge of the blade is a blade holder that protects the user's fingers when placed over the top edge of the blade during use. Disposed under the blade holder is an optional blade stabilizer and a spring that acts as a biasing means to limit the amount of cutting pressure applied. Attached to the proximal end of the handle is an adjustable strap designed to wrap around the user's forearm and elbow joint. During use, the user presses his or her index finger downward against the blade holder to impart a downward cutting action. Formed over the upper edge of the blade is an optional blade stabilizer.

This is a utility patent application which claims benefit of U.S. Provisional Application No. 60/783,112 filed on Mar. 16, 2006.

### BACKGROUND OF THE INVENTION

1. Field of the Invention

This invention relates generally to knives and more particularly to knives that are braced and controlled by the user's arm when cutting.

2. Description of the Related Art

Fiberglass insulation is commonly used to insulate the walls, floors, and ceiling in buildings. Such insulation is sold in rolls or sheets 6 to 8 feet in length and 16 to 24 inches in width. The insulation, which is typically 6 to 8 inches thick, is pressed between the wall, floor or ceiling structural members. Often, excess amounts of the insulation must be cut off with a sharp utility knife so that it fits properly between the structural members.

When installing insulation, workers must often work in restricted locations. Often the insulation must be cut to size prior to being installed between structural members. Because of its insulation's thickness and tendency to tear, a sharp blade must be used on the knife and considerable force must be applied when cutting insulation. Unfortunately, a utility knife when used on a daily basis to cut insulation, can lead to an inflammatory medical condition of the wrist, such as carpel tunnel symptom. In order to prevent such conditions, healthcare professionals recommend that their inflicted patients rest and stop using their wrists.

What is needed is a sharp knife that can be used to cut insulation and other types of material that includes an elongated handle that enables the user to reach high locations and use his or her upper arm and shoulder muscles rather than the wrist to exert pressure on the knife.

### SUMMARY OF THE INVENTION

These and other objects are met by insulation knife and method disclosed herein used for cutting thick material that is hard to cut, such as insulated fiberglass. The knife includes an elongated handle having a distal end and proximal end with an adjustable loop strap attached to its proximal end. Longitudinally aligned and attached to the distal end of the elongated handle is an elongated blade. The knife includes a blade holder that keeps the blade longitudinally aligned on the end of the handle. The blade holder is L-shaped and includes an upper edge that partially extends over the top edge of the blade to hold the blade in a longitudinally aligned place when a downward force is exerted on the blade. The upper edge of the blade holder also protects the user's finger when pressed against the top edge of said blade during use. Disposed under the blade holder is a blade cover to further protect the user's finger, and an optional blade stabilizer that stabilizes the exposed portion of the blade when cutting through thick material.

In the first embodiment, the blade is securely attached to the distal end of the handle. In a second embodiment, a biasing means is disposed between the blade and the distal end of the handle which limits the amount of cutting force exerted on the blade.

Both embodiments include an adjustable strap attached to the proximal end of the handle. During use, the strap is wrapped around the user's forearm to hold the knife adjacent to the forearm so that the entire arm may be used to swipe the knife through thick material, such as fiberglass insulation. During use, the user is able to longitudinally align and press his or her index finger downward against the blade holder or the blade cover to more accurately aim and impart a downward cutting action on the knife. During use, the wrist and elbow joints are locked so that only the upper arm or shoulder is used when cutting. The knife is held in one hand so that only light pressure is exerted on the user's palm when cutting. By locking the wrist and elbow, the upper arm and shoulder are the primary anatomical structures that exert a downward force on the knife thereby reducing wrist and elbow injuries.

Also disclosed herein is a method for cutting think fibrous material such as fiberglass.

### DESCRIPTION OF THE DRAWINGS

FIG. 1 is an illustration showing a worker reaching upward to cut a piece of fiberglass insulation located between the wall studs.

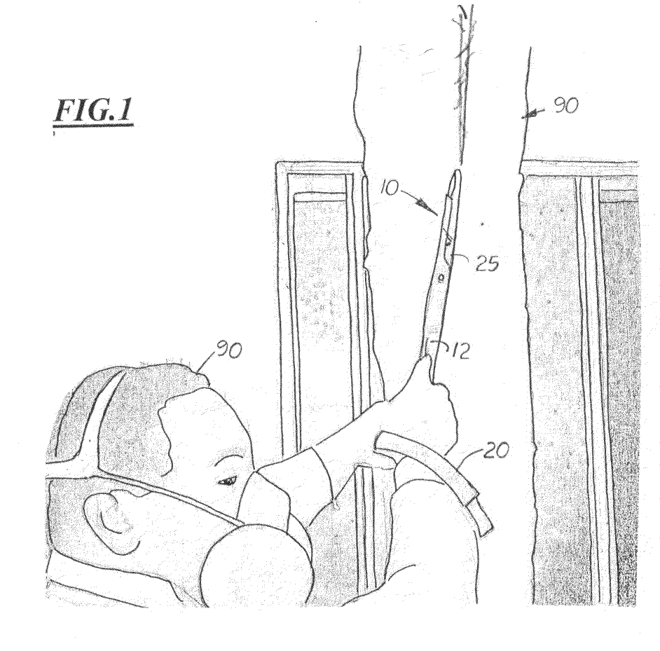

FIG. 2 is an illustration showing a worker holding the insulation knife.

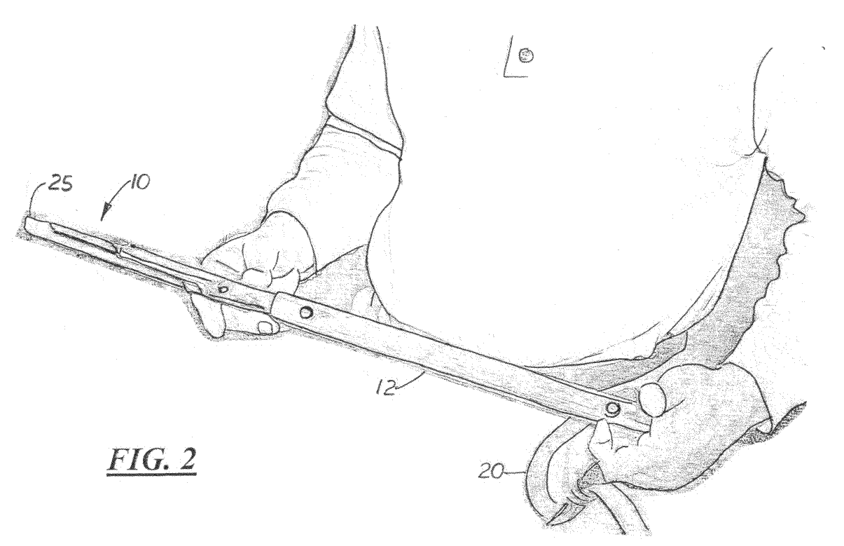

FIG. 3 is an illustration showing the knife properly positioned on a user's hand and arm.

FIGS. 4A-C are side elevational views of the knife.

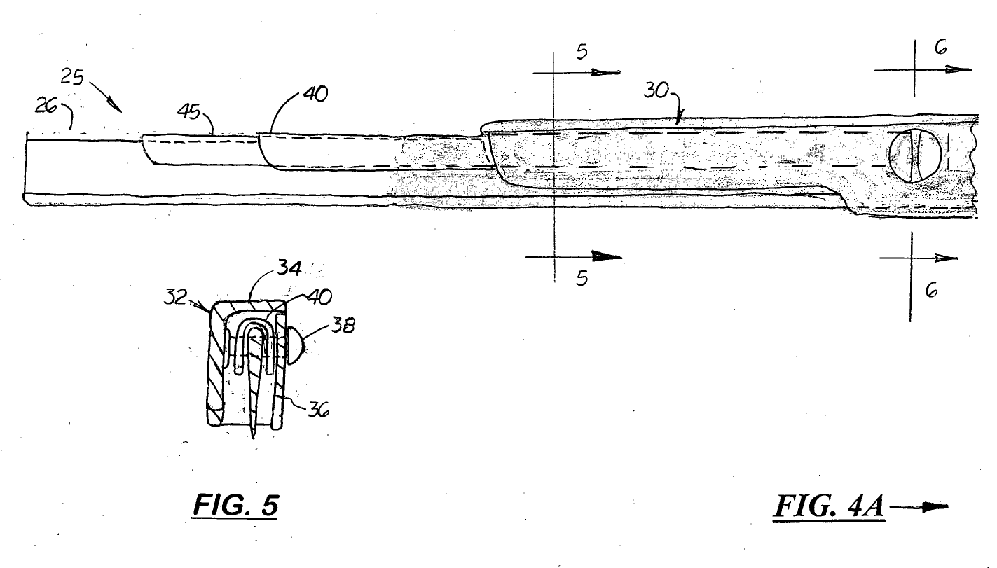

FIG. 5 is a sectional view taken along line 5-5 in FIG. 4A

FIG. 6 is a sectional view taken along line 6-6 in FIG. 4A

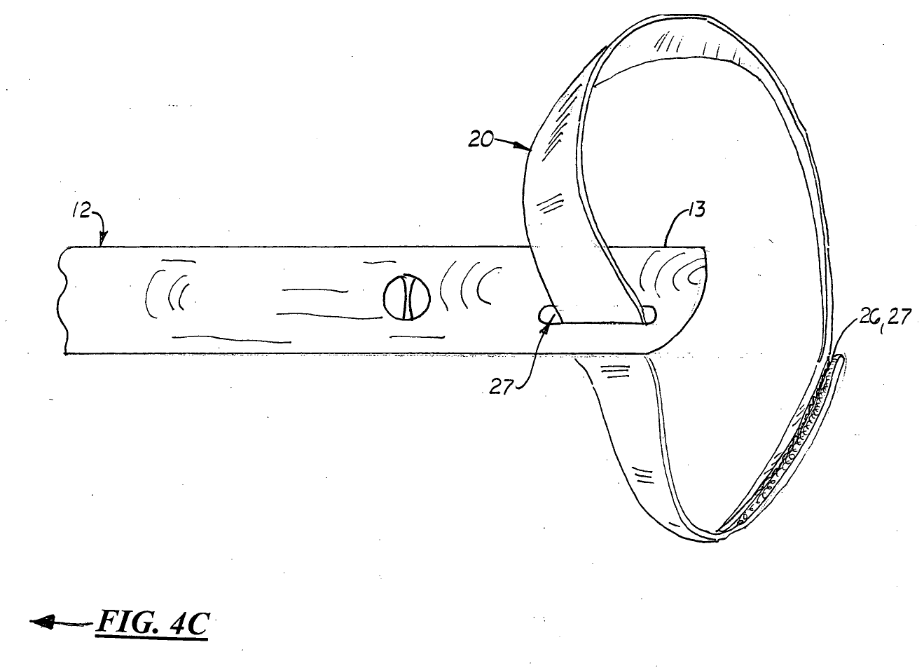

FIG. 7 is a perspective view of the distal end of the knife showing the relative position of the blade, the blade holder, and the blade stabilizer.

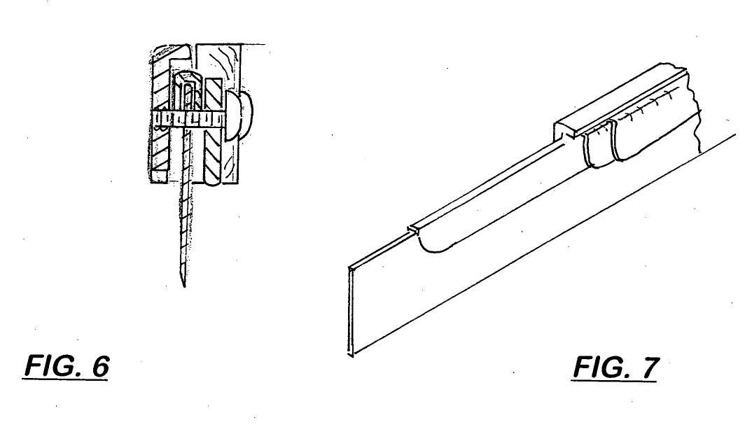

FIG. 8 is a side elevational view of the second embodiment of the knife with a biasing means disposed between the blade and the handle.

### DESCRIPTION OF THE PREFERRED EMBODIMENT(S)

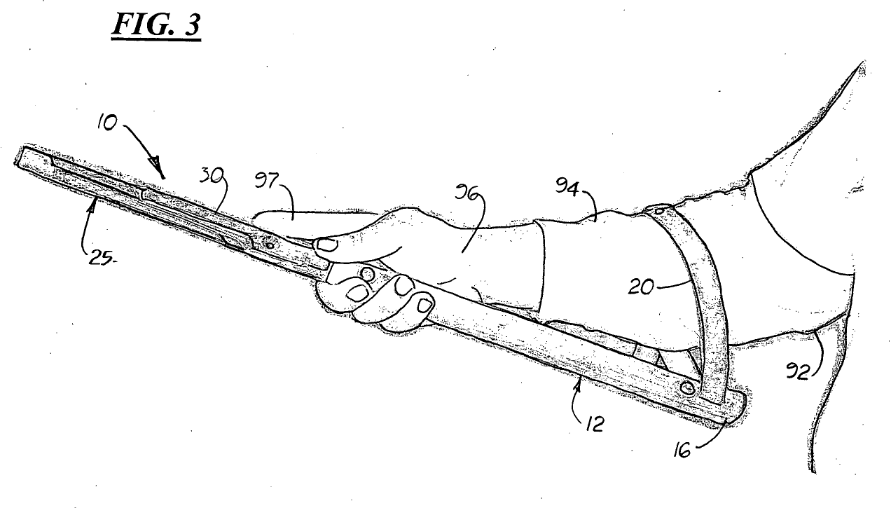

The present invention discloses a knife 10 and method used for cutting thick material, such as fiberglass insulation 90, that includes an elongated handle 12 (16 to 24 inches in length) with an elongated blade 25 longitudinally aligned and attached to the distal end 14 of the handle 12. As shown in FIG. 3, attached to the opposite proximal end 16 of the handle 12 is an adjustable strap 20 designed to wrap around the user's forearm 94 near the elbow joint 92 to longitudinally align the knife 10 with the forearm 94. During use, the elbow joint 92 and wrist 96 are locked and the index finger 97 is longitudinally aligned over the blade holder 30.

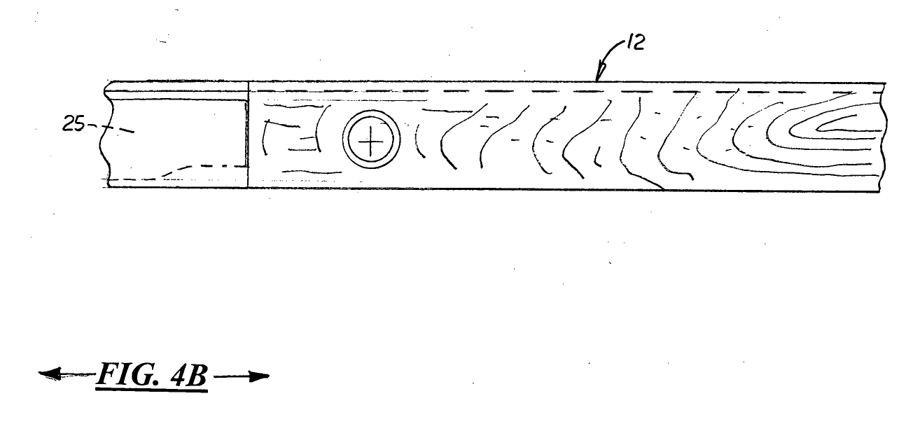

The blade 25 is held longitudinally over the distal end of the handle 12 by a blade holder 30. As shown in FIG. 5, the blade holder 30 includes an L-shaped back plate 32 longitudinally aligned with the back surface of the handle 12 and a flat front plate 36. The back plate 32 and the front plate 36 are forced together by a threaded screw 38. Disposed between the two plates 32, 36 is the elongated blade 25. The back plate 32 includes an upper flange surface 34 that extends perpendicular over the top edge 26 of the blade 25 that prevents the blade 25 from rotating upward when downward force is exerted on the distal end of the handle 25.

The blade 25 extends beyond the distal end of the two plates 32, 36. Disposed over the top edge 26 of the blade 25 is an elongated, inverted U-shaped blade cover 40. The blade cover 40 extends partially under the upper flange surface 34 of the back plate 32. During use, user's index finger 97 is press downward to impart a downward force onto the blade cover 40 while the blade cover 40 protects the index finger 97 from cuts.

Extending forward from the handle 12, and under the blade holder 30 and under the blade cover 40 is an optional blade stabilizer 45. The blade stabilizer 45 is a thin inverted U-shaped structure which also fits over the top edge of the portion of the blade 25 that extends from the blade cover 40. During use, the blade stabilizer 45 is used with longer blades or when cutting resistant material that would cause the blade 25 to bend when cutting.

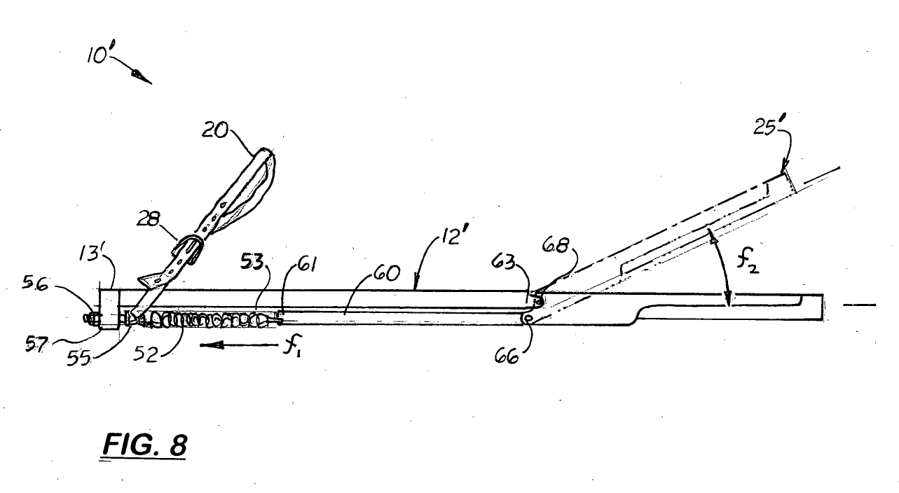

The adjustable strap 20 is attached to the proximal end 13 of the handle 12. In the preferred embodiment, an elongated slot 27 is formed in the handle 12 through which the strap 20 is extended. The strap 20 is sufficiently in length so that when the handle 12 may be longitudinally aligned under the user's forearm, the strap 20 may be wrapped around the user's forearm near or at the elbow joint. When properly connected, the handle 12 adjacent to the posterior surface of the foreman and the proximal end 13 of the handle 12 is near the elbow joint 92. A length adjustable locking means, such as hook and loop surfaces 26, 27 are formed on the adjoining surfaces of the strap 20 or a buckle 28 (see FIG. 8) is provided on the strap 20 with allows it to be selectively adjusted in length and fixed in a secure position around the user's forearm.

FIGS. 8 shows a second embodiment of the knife (indicated by 10′) that includes a biasing means disposed between the distal end of the handle 12′ and a rotating blade 25′. When cutting, it is common for the individual to apply as much force as they can to ensure that the material is cut. The first cutting pass may require 12 lbs of pressure, yet the individual may apply 25-30 lbs. By including a biasing means, the user is able to adjust the amount of cutting pressure applied. In the preferred embodiment, the biasing means includes a spring 52 attached at its proximal end 53 to a length adjustable D-ring 55. The D-ring 55 is attached to a threaded bolt 56 that extends through a downward extending bracket 57 attached to the proximal end 61 of the handle 12′. The distal end 53 of the spring 52 is attached to the proximal end of an elongated thin bar 60. The distal end 63 of the bar 60 is attached to the proximal end of the blade 25′ via a pin 66. The blade 25′ is pivotally attached to the distal end of the handle 12′ via a second pin 68.

In the preferred embodiment, the knife 10 measures approximately 20 to 26 inches in length. The handles 12, 12′ measures approximately 8 to 10 inches in length and the blade 25, 25′ measures 12 to 16 inches in the length. The blade holder 30 is approximately 6 to 8 inches in length. The blade cover 40 is approximately 4 to 6 inches in length. The adjustable strap 20 is approximately 10 inches in length.

Also disclosed herein is a method for cutting think fibrous material such as fiberglass, comprising the following steps:

a. selecting a knife with an elongated handle and a longitudinally aligned blade attached thereto, said blade including a blade holder that partially covers the top edge of the blade, said knife also include an arm strap that enables said knife to be longitudinally aligned on the arm so that when said strap is attached to said forearm and said index finger is extended over said blade holder and said wrist and elbow are locked in position, said fibrous material can be cut;

b. attaching said knife to said forearm of a user;

c. positioning the open end of the blade against said fibrous material at a desired location for cutting and locking said wrist and elbow joint in a fixed straight position; and,

d. moving said knife in a downward direction so that said blade cuts through said fibrous material.

In compliance with the statute, the invention described herein has been described in language more or less specific as to structural features. It should be understood however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. An arm brace cutting knife, comprising;
a. an elongated handle having a distal end and proximal end;
b. an adjustable loop and strap attached to said proximal end of said elongated handle;
c. an elongated blade longitudinally aligned with said handle, said blade including a sharp lower edge; and, d. a blade holder longitudinally aligned and attached to said distal end of said handle, said blade holder including an upper edge that extends over a portion of said blade to protect a user's finger when pressing against said blade.

2. The arm brace cutting knife, as recited in claim 1, further including a blade cover disposed over the top edge of said plate to protect the user's finger when pressed firmly over said blade.

3. The arm brace cutting knife, as recited in claim 1, further including a blade stabilizer to stabilize the distal end of said blade when said knife is used for cutting.

4. The arm brace cutting knife, as recited in claim 2, further including a blade stabilizer to stabilize the distal end of said blade when said knife is used for cutting.

5. The arm brace cutting knife, as recited in claim 1, further including a biasing means disposed between said handle and said blade.

6. The arm brace cutting knife, as recited in claim 5, wherein said biasing means is a longitudinally aligned spring attached at one end to said blade and at an opposite end to said handle.

7. The arm brace cutting knife, as recited in claim 2, further including a biasing means disposed between said handle and said blade.

8. The arm brace cutting knife, as recited in claim 3, further including a biasing means disposed between said handle and said blade.

9. A method for cutting think fibrous material such as fiberglass, comprising the following steps:
a. selecting a knife with an elongated handle and a longitudinally aligned blade attached thereto, said blade including a blade holder that partially covers the top edge of the blade, said knife also include an arm strap that enables said knife to be longitudinally aligned on the arm so that when said strap is attached to said forearm and said index finger is extended over said blade holder and said wrist and elbow are locked in position, said fibrous material can be cut;
b. attaching said knife to said forearm of a user;
c. positioning the open end of the blade against said fibrous material at a desired location for cutting and locking said wrist and elbow joint in a fixed straight position; and,
d. moving said knife in a downward direction so that said blade cuts through said fibrous material.
